(19) United States
(12) Patent Application Publication
(10) Pub. No.: US 2024/0211522 A1
(43) Pub. Date: Jun. 27, 2024

(54) CHARGING LOCATION SEARCH ENGINE IN AN ELECTRIC VEHICLE MANAGEMENT SYSTEM

(71) Applicant: Rivian IP Holdings, LLC, Plymouth, MI (US)

(72) Inventors: Chakravarthy K. ALLAMSETTY, San Jose, CA (US); Connie Wong YANG, Saratoga, CA (US); Martin Munther HERMEZ, Long Beach, CA (US); Tyler Jennings BENNETT, Long Beach, CA (US)

(21) Appl. No.: 18/085,776

(22) Filed: Dec. 21, 2022

(51) Int. Cl. G06F 16/9537; G01C 21/36; G06F 16/2455; G06F 16/2457; G06F 16/248; G06F 16/9535

(52) U.S. Cl. CPC G06F 16/9537; G01C 21/3679; G06F 16/24556; G06F 16/24578; G06F 16/248; G06F 16/9535

(57) ABSTRACT

Methods, systems, and computer storage media for providing a charging location search result for an electric vehicle (EV) based on a charging location search engine in an electric vehicle management system. The electric vehicle management system may integrate the charging location search engine with a location-based service for providing the charging location search result. The charging location search result can be based on ranking data or rating data associated with charging location features. Ranking data and rating data are aggregated to support providing charging location search results. Operationally, a request for a charging location for an EV is received. The request comprises a plurality of charging location request attributes associated with the EV. Using an electric vehicle management system, a charging location search result is determined based on the plurality of charging location request attributes and the ranking data or the rating data. The charging location search result is communicated.

### INTRODUCTION

Drivers rely on electrical power to power electric vehicles (EVs). Charging stations use electrical power to charge EVs. Charging stations at different charging locations can have different charging features and can be located at different distances from an EV that needs to be charged.

### SUMMARY

Various aspects of the technology described herein are generally directed to systems, methods, and computer storage media for, among other things, providing a charging location search result for an electric vehicle based on a charging location search engine in an electric vehicle management system. The electric vehicle management system may integrate the charging location search engine with a location-based service (e.g., a location-based service engine) for providing the charging location search result. The charging location search result can be based on ranking data or rating data associated with charging location data (i.e., charging location ranking features and charging location rating features). Ranking data and rating data are aggregated to support providing charging location search results. For example, the electric vehicle management system can aggregate charging location data that includes charging location ranking features (e.g., type of charging supported, connector types, and status of charging stations) and charging location rating features (e.g., user ratings for convenience, safety, and reliability). The charging location search result may also be based on an existing or anticipated navigation route, where the navigation route is associated with a request for a charging location.

Operationally, a request for a charging location for an electric vehicle (EV) is received at an electric vehicle management system. The request comprises a plurality of charging location request attributes associated with the EV. For example, charging location request attributes can include user data (e.g., user navigation preferences and user charging location preferences), EV data (e.g., EV type, EV charging specifications, and EV battery range), and a navigation route that are included in the request. Using an electric vehicle management system, a charging location search result is determined based on the plurality of charging location request attributes and the ranking data or the rating data. The charging location search result is communicated to a client of the electric vehicle management system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIGS. 1A and 1B are block diagrams of exemplary schematics of a charging management system for providing charging location search results, in accordance with aspects of the technology described herein;

FIG. 2A a schematic diagram of an exemplary charging management system for providing charging location search results, in accordance with aspects of the technology described herein;

FIG. 2B is a schematic diagram of an exemplary charging management system for providing charging location search results, in accordance with aspects of the technology described herein;

FIG. 3 is a flow diagram of an exemplary method for providing charging location search results in a charging management system, in accordance with aspects of the technology described herein;

FIG. 4 is a flow diagram of an exemplary method for providing charging location search results in a charging management system, in accordance with aspects of the technology described herein;

FIG. 5 is a flow diagram of an exemplary method for providing charging location search results in a charging management system, in accordance with aspects of the technology described herein;

FIG. 6 is a block diagram of an exemplary electric vehicle management system suitable for use in implementing aspects of the technology described herein;

FIG. 7 is a block diagram of an exemplary distributed computing environment suitable for use in implementing aspects of the technology described herein; and

FIG. 8 is a block diagram of an exemplary computing environment suitable for use in implementing aspects of the technology described herein.

### DETAILED DESCRIPTION OF THE INVENTION

An electric vehicle management system can support a network of resources and services to support electric vehicle management operations associated with navigation, autonomous driving, charging management, and so on. A charging station system (e.g., a charging station) of an electric vehicle management system can operate as part of the electric vehicle (EV) management system to provide charging or other suitable charging management services and operations. In particular, the charging station system may deliver electrical power to an EV to power the EV for transportation and other functionality. Charging station systems for EVs can be available anywhere with electrical power for a charging station.

Drivers of electric vehicles (EVs) can communicate requests—via an electric vehicle management system or automotive navigation system—for charging locations with charging stations to recharge their EVs. An electric vehicle management system client or an automotive navigation system client of an EV or a client device can support processing requests for identifying charging stations. For example, the automotive navigation system and automotive navigation system client can support identify a charging location—and specifically identify one or more charging locations along a trip navigation route of the driver. The automotive navigation system may use a location-based service to assist in identifying charging locations. Automotive navigation systems and location-based services currently rely on search algorithms that historically have been associated with gas-powered vehicles and gas-powered vehicle features. Traditional search algorithms have not been optimized for EV features (e.g., functionality, specifications, and requirements), and user EV-based features (e.g., user EV-related preferences) and EV management systems.

Moreover, charging location searching solutions of electric vehicle management systems do not utilize or provide comprehensive information about the charging locations and charging stations. For example, an electric vehicle management system may not be configured to exclude less favorable charging locations from charging location search results based on different types of programmatically aggregated information about the charging locations, charging stations. The comprehensive aggregated information can specifically relate to EV features and user EV-based features. Developing an improved charging location searching technical solution can be particularly challenging because of some of the existing infrastructure and limitations described above. As such, a more comprehensive electric vehicle management system—with an alternative basis for providing charging location search results including charging stations—can improve operations and interfaces associated with electric vehicle management systems.

Embodiments described herein are generally directed to systems, methods, and computer storage media for, among other things providing a charging location search result for an electric vehicle (EV) based on a charging location search engine in an electric vehicle management system. The electric vehicle management system may integrate the charging location search engine with a location-based service for providing the charging location search result. The charging location search result can be based on ranking data or rating data associated with charging location features. Ranking data and rating data are aggregated to support providing charging location search results. Operationally, a request for one or more charging locations for an EV is received. The request comprises a plurality of charging location request attributes associated with the EV. Using an electric vehicle management system, a charging location search result is determined based on the plurality of charging location request attributes and the ranking data or the rating data. The charging location search result is communicated to a client of the electric vehicle management system.

At a high level, a charging location search is identified based on charging location request attributes, ranking data, and rating data. Charging location request attributes refer to explicit parameters or derived parameters that are selected to identify charging locations. The charging location request attributes can include user data (e.g., user navigation preferences, user charging location preferences), EV data (e.g., EV type, EV charging specifications, EV battery range) the support identifying the charging location recommendation. The charging location request attributes can correspond to ranking data (i.e., values of charging location ranking features) or rating data (i.e., values of charging location rating features) or both. Ranking data can refer to values that correspond to features of a charging location (e.g., type of charging supported, connector types, status of charging stations, and compatibility with EVs); rating data can refer to values of features of user ratings (e.g., convenience, safety, reliability) of a charging location. User ratings can be first-party user ratings or third-party user ratings—such as RIVIAN app or YELP app, respectively.

The charging location search engine implements a search algorithm that is based on the charging location request attributes and least one of the ranking data and rating data. An automotive navigation engine provides an integrated searching platform including the charging location search engine and a location-based service (especially when implemented via a third-party provider). Advantageously, the charging location search engine prevents selecting charging locations that are less favorable based on using the ranking data and the rating data.

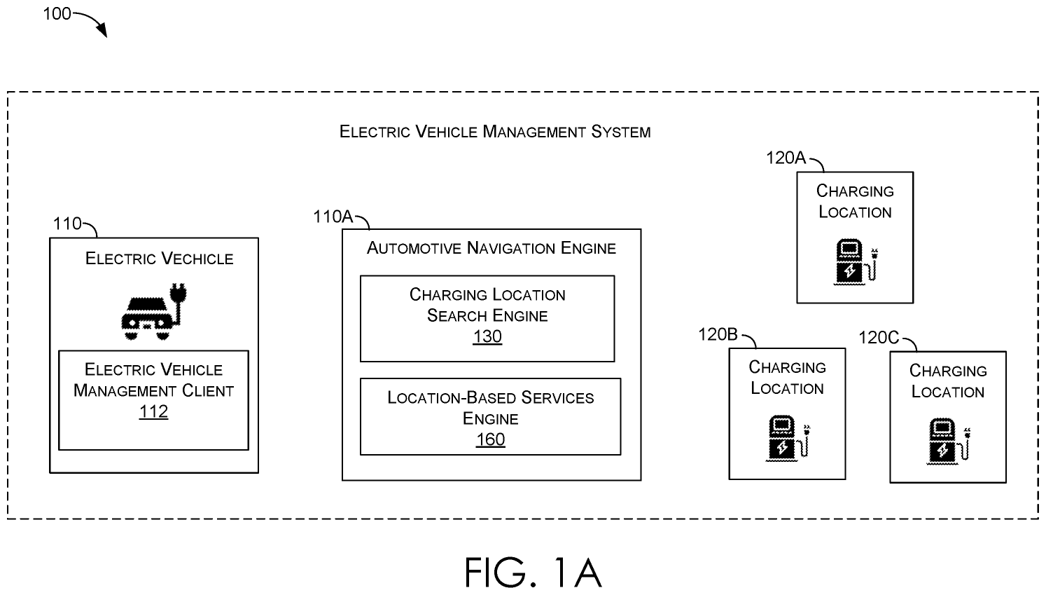

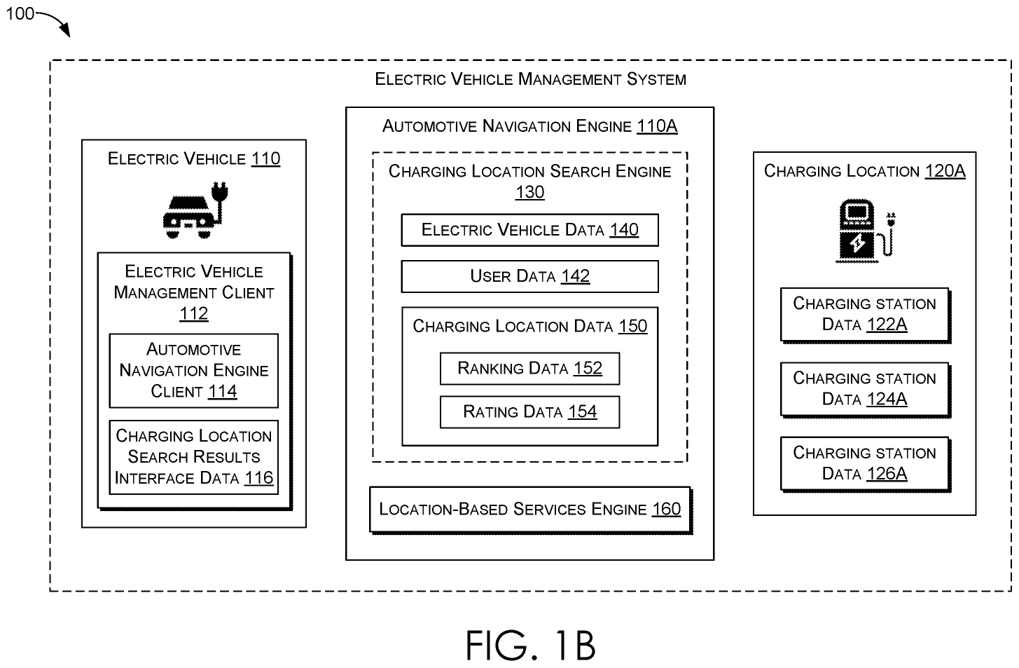

Aspects of the technical solution can be described by way of examples and with reference to FIGS. 1A and 1B. FIG. 1A illustrates electric vehicle management system 100 (charging management system) having electric vehicle 110 with electric vehicle management client 112; automotive navigation engine 110A with charging location search engine 130 and location-based services engine 160; and charging location 120A, charging location 120B, and charging location 120C.

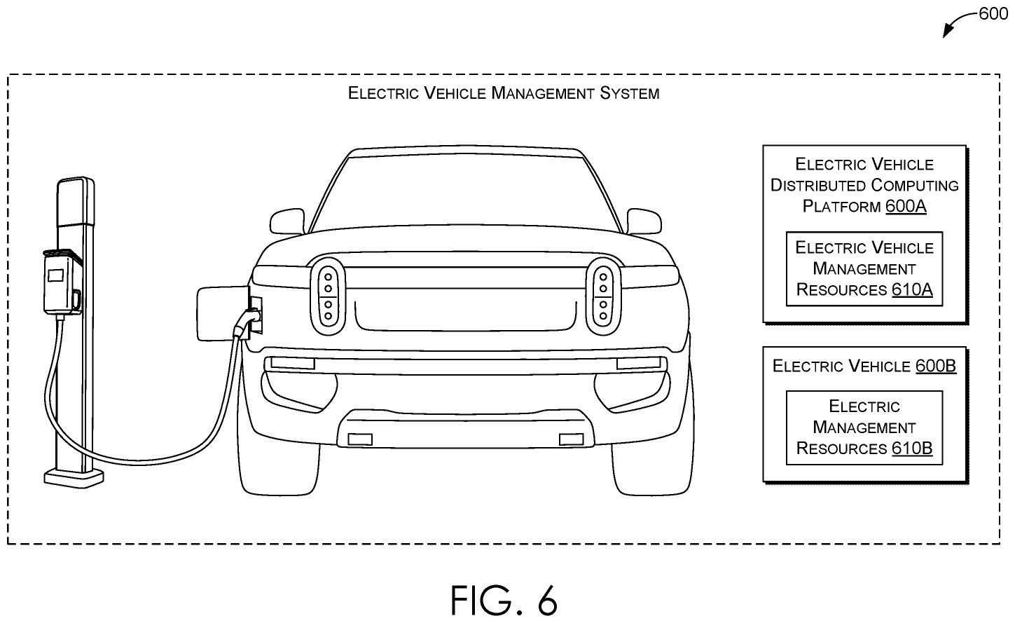

Operationally, an electric vehicle management system 100 can provide electric vehicle management features (e.g., a cloud-based network of applications, services, and hardware and software resources) that support different aspects (e.g., infotainment, autonomous driving, and charging system management) of an electric vehicle management system. The electric vehicle management system 100 may operate on a cloud computing platform—such as the cloud computing platform described herein with reference to FIG. 6. The electric vehicle management system supports functionality described herein associated with an electric vehicle (e.g., electric vehicle 110). Electric vehicle 110 may be one of a plurality of electric vehicles in an electric vehicle fleet. An electric vehicle fleet refers to a group of electric vehicles belonging to a company or used for a business purpose. A driver may drive the electric vehicle 110 that includes electric vehicle management client 112 that provides client-side access to the electric vehicle management features. Other devices can include clients that support client-side access to electric vehicle management features (e.g., mobile device—not shown).

Charging location (e.g., charging station 120A, charging station 120B, and charging station 120C) can refer to a charging location having charging location features (e.g., charging location ranking features and charging location rating features) including one or more charging stations that operates charge points. The charging station (e.g., electric vehicle supply equipment “EVSE”) and electric vehicle 110 can communicate via an EV charging protocol that defines the type of connector for an inlet of the electric vehicle 110, max power and voltage for the connection, type of communication link, and communication protocols. A charging station connects the electric vehicle 110 to an electrical supply and further supports communicating real time charging station data via the automotive navigation engine 110.

The automotive navigation engine 110A can operate as a central management system (e.g., a cloud-based backend system) such that the charging location search engine 130 communicates with the EV 110 for charging location search engine operations. The automotive navigation engine 110A is responsible for providing a computing infrastructure that supports navigating the EV 110. The automotive navigation engine 110A can provide automotive controls to find directions in the EV 110. The automotive navigation engine 110A operates with the location-based services engine 160. The location-based services engine 160 supports services including Global Positioning System (GPS) satellite navigation, local search, automotive navigation, and mobile advertising. The location-based service engine 160 can support charging location searches based on a location of an EV or a user using network technology or mobile-device-based technology.

With reference to FIG. 1B, FIG. 1B illustrates electric vehicle management system 100 (charging management system) having electric vehicle 110 with electric vehicle management client 112 including automotive navigation client 114 and charging location search results interface data; automotive navigation engine 110A with charging location search engine 130 including electric vehicle data 140 and user data 142; charging location data 150 including ranking data 152 and rating data 154; location-based services engine 160; and charging location 120A with charging station data 122A, charging station data 124A, and charging station data 126A.

The automotive navigation engine 110A operates with the location-based services engine 160 to aggregate charging location data. Charging location data (e.g., value of charging location ranking features and charging location rating features) is associated with a plurality of charging locations. The charging locations can have different types of charging location features. Charging location features can include different types of locations (e.g., gas station or parking garage at mall, office building, or apartment building) and their corresponding addresses. Charging location features can also include the different types charging stations and their corresponding functionality. For example, a charging location can have charging stations for AC or DC charging with different levels and a plurality of different connectors for the charging stations. The charging location data is programmatically aggregated and maintained as values associated with either charging location ranking features or charging location rating features to support ranking and rating the charging location and charging stations. The charging locations can be searched via an integrated location-based service as a point of interest (POI) in the electric vehicle management system having an automotive navigation engine and a charging location search engine.

Charging location data includes ranking data and rating data. Ranking data is associated with charging location ranking features and rating data is associated with charging location rating features. The charging location ranking features are characteristics of charging locations—from the charging location data—that have been identified to rank charging locations including charging stations relative to each other. For example, a number of charging stations, the types of charging stations and hours of service, are charging location ranking data features that are used to rank charging locations and even more granularly charging stations. Moreover, an EV provider can mine a plurality of charging location ranking features from historical EV information (e.g., EV features or user-based EV features) associated with their EV platform and identify a sub-set of information that is relevant to ranking charging locations relative to each other. In this way, the ranking data is derived from the EV information associated with the EV platform.

The charging location rating features are characteristics of charging locations—from the charging location data—that are identified to rate charging locations based on user ratings associated with the charging location rating features. Crowd-sourced ratings associated with safety, convenience, accessibility can be used to rate charging locations. For example, a first-party application or a third-party application can be used to gather user ratings for a plurality of charging location rating features. The rating data from the first-party application can be supplemented with rating data from the third-party application. The rating data from the first-party application can include charging location rating features that correspond to EV features and user EV-based features of an EV associated with first-party application. The ranking data and rating data can be identified specifically to support generating charging location search results in combination with charging location request attributes from request searching for charging locations. Other variations and combinations of charging locations and charging location data features in charging location data are contemplated with embodiments described herein.

Charging location data of charging locations and charging stations at the charging locations can be stored in a charging location data schema. For example, the charging location may be a parking garage having a first AC charging station and a second AC charging station. The charging locations or charging stations can also be first-party charging locations or charging stations (i.e., directly associated with the electric vehicle management system) or third-party charging locations or stations (e.g., indirectly associated with the electric vehicle management system). For example, a first-party charging station can include a charging management client that allows the electric vehicle management system to query the status of the charging station and perform other types of charging management operations; however, the third-party charging station may not be accessible or have limited interoperability with electric vehicle management system. The charging location data schema can include charging location data that is aggregated—periodically or in real time—for the charging locations. In this way, identifying charging location search results can be done in an online mode or offline mode, as discussed below.

The charging location search engine 130 is responsible for providing charging location search results. The charging location search engine 130 receives a request for a charging location. For example, the request can be received from an EV on a particular navigation route (e.g., a local route plan or a trip route plan), or the request can be received from an automotive navigation engine client 122. The automotive navigation engine client 122 operates to facilitate client-side operations associated with the automotive navigation engine 110A. The request refers to a query for information retrieval (i.e., a charging location). The query is used to map parameters (e.g., charging location request attributes) of the query to parameters (e.g., charging location data including ranking data and rating data) of the information known about the charging locations.

The request includes charging location request attributes. Charging location request attributes include information that is used to construct the query that is communicated to the charging location search engine 130 to identify charging locations. For example, the charging location request attributes can be include EV data (e.g., EV type, EV charging specifications, EV battery range, navigation route) and user data (e.g., user navigation preferences, user charging location preferences). The charging location request attributes may also be retrieved from a storage resource (e.g., a user profile or EV profile) or can be received or updated via an interface associated with the receiving the request. For example, the request may be received with explicit selections of charging station request attributes.

The request can be associated with a navigation route of the EV, such that the charging location recommendation is further generated based on the navigation route. The navigation route can be a local route plan associated with local planning features or a trip route plan associated with trip route planning features. The navigation route can be an existing navigation route or an anticipated navigation route. The navigation route and features of the navigation route are provided as charging location request attributes in the request for a charging location. For example, when an EV driver communicates a request associated with a trip route plan, the additional features (e.g., traffic conditions, weather conditions, time of day) of the trip route plan are communicated with the request to support determining a charging location. In particular, the trip route plan can be updated based on a charging location—and specifically a charging location that is identified based on charging location ranking data and charging location rating data of charging locations along the trip route plan.

The charging location search engine 130 is an information retrieval system designed to help find charging locations based on different types of data known about the charging locations. The charging location search engine 130 operates with the location-based services engine 160 to identify charging locations. It is contemplated that the location-based service engine 160 can be integrated via a third-party client that provides functionality associated with location-based services as described above. In this way, the charging location search engine 130 and the location-based services 160 support an integrated search platform.

The charging location search engine 130 determines a charging location based on the plurality of charging location request attributes and one or more of ranking data or rating data. It is contemplated that the charging location search result is determined as an explicit result or a charging location recommendation for the request. Moreover, a plurality of charging location search results can be identified with the plurality of charging location search results ranked based on satisfying the charging location request attributes. The charging location search engine 130 can retrieve real-time charging location data (e.g., values for charging location ranking features). For example, a current status of a charging station of a charging location can be identified “working” or “defective”. The charging station may also have other types of issues including slow charging, no heartbeat, or an intermittent fault status that are captured as either charging location ranking features or charging location rating features that are used in determining the charging location.

Determining the charging location can performed in an online mode or offline mode. The online mode can refer to when the charging location search engine 130 is in communication (e.g., via a network) with the automotive navigation engine 114. The charging location search engine 130 can operate to communicate with the automotive navigation engine client 114 in the online mode to identify a charging location. However, in an offline mode—that refers to when the charging location search engine is not in communication with the automotive navigation engine 114—the automotive navigation engine 114 can generate charging location search result based on cached information associated with charging location ranking features or charging location rating features. In the way, the automotive navigation engine 114 can be configured to implement the same search algorithm with limited data in an offline mode—where the search algorithm is associated with identifying a charging location based on charging location data.

In operation, the plurality of charging location request attributes (e.g., a first charging location request attribute and a second charging location request attribute) are identified in the request. Based on the plurality of charging location request attributes, a determination is made whether ranking data or rating data or both are used determine a charging location. For example, if the first charging location attribute and the second charging location attribute are ranking data attributes, then only the ranking data is used to identify the charging location search result. If the first charging location attribute and the second charging location attribute are in the ranking data and the rating data respectively, then both the ranking data and rating data are used to identify the charging location search result.

Upon determining that the ranking data or rating data or both are used to determine the charging location, the plurality of charging location request attributes are evaluated to find a charging location with charging location features that match the charging location request attributes. For example, the charging location request attributes can include user data or EV data that are associated with a charging location ranking features; or the charging location request attributes can include user data or EV that are associated with charging location rating features. As discussed, the navigation route and user data and EV data associated with the navigation route can also be charging location request attributes that are associated with the request.

The charging location search engine determine charging location based on the plurality of charging location request attributes and one or more of the ranking data or rating data is based on matching the plurality of charging location request attributes to charging location ranking features of the ranking data or charging location rating features of the rating data. A matching algorithm can be implemented to generate a charging location search result score between the charging location request attributes and the ranking data or rating data. The charging location search result score can further be used to rank a plurality of charging location search result locations that are identified for a request. The matching algorithm can include a dynamic weighting scheme that is associated with the ranking data or rating data. In particular, different charging location data that are selected and are provided different weights when determining the charging location search result. Moreover, as rating data and ranking data—and their corresponding charging location ranking features or charging location rating features—are continually developed, a weighting scheme for performing charging location searches can be updated.

The charging location search engine 130 communicates the charging location search result. The charging location search result can be communicated to an automotive navigation engine client 114. The automotive navigation engine client 114 can cause presentation of the charging location search result. The charging location search result can be associated with charging location search results interface data that include additional features associated with the charging location search result that can be caused to be presented alongside the charging location search result. The additional features can be associated charging location data including ranking data (e.g., charging location ranking features) or rating data (e.g., charging location rating features) that are associated with the charging location search result. For example, the charging location search result can be provided on a navigation route of the EV on a graphical user interface that further identifies charging location data that correspond to the plurality of charging location request attributes and other types of charging location data associated with the charging location search result. In another example, the additional features can communicate that the charging location search was performed in an online or offline mode; explicitly identify ranking data or rating data; or provide—via a charging location search results interface—status information of a plurality of different charging locations or charging stations associated with a request. Other variations and combinations of operations for presenting the charging location search result and charging location search results interface data corresponding to charging location data are contemplated with embodiments described herein.

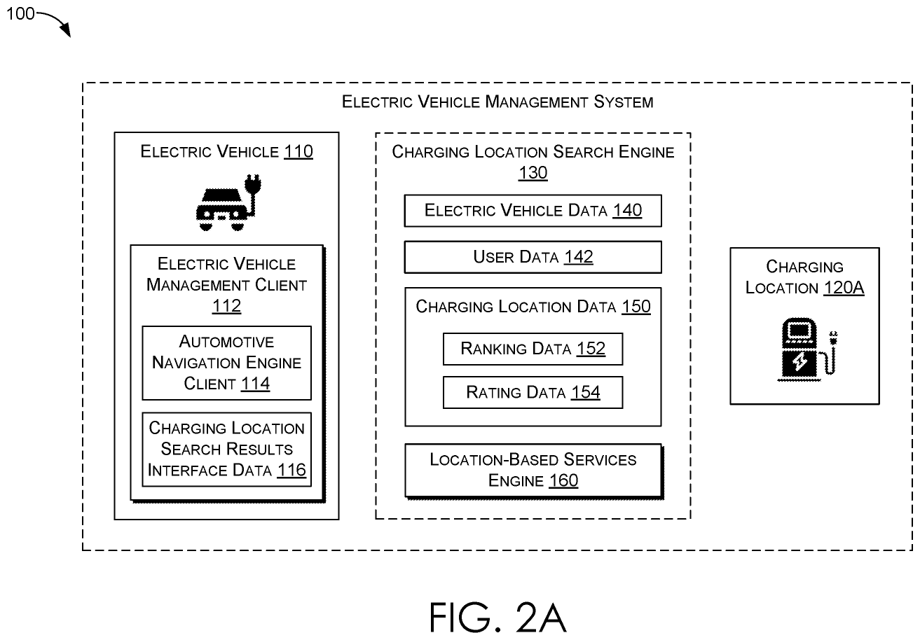

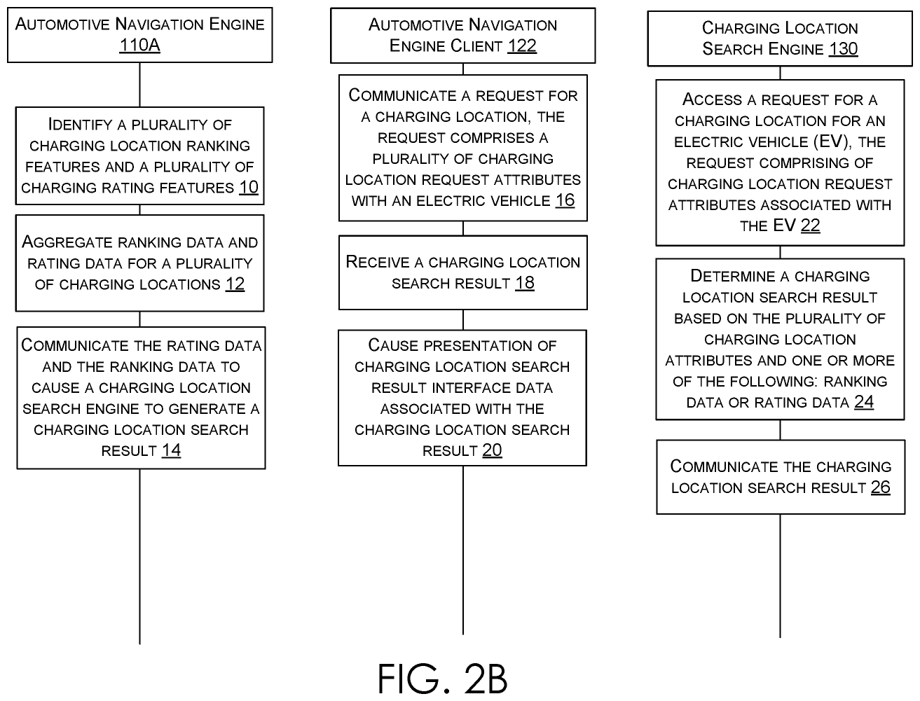

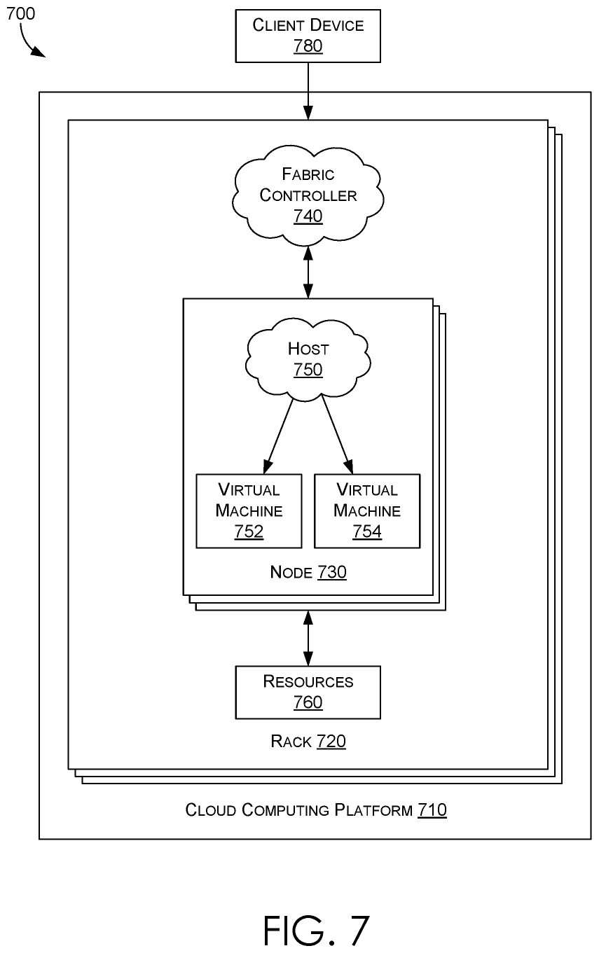

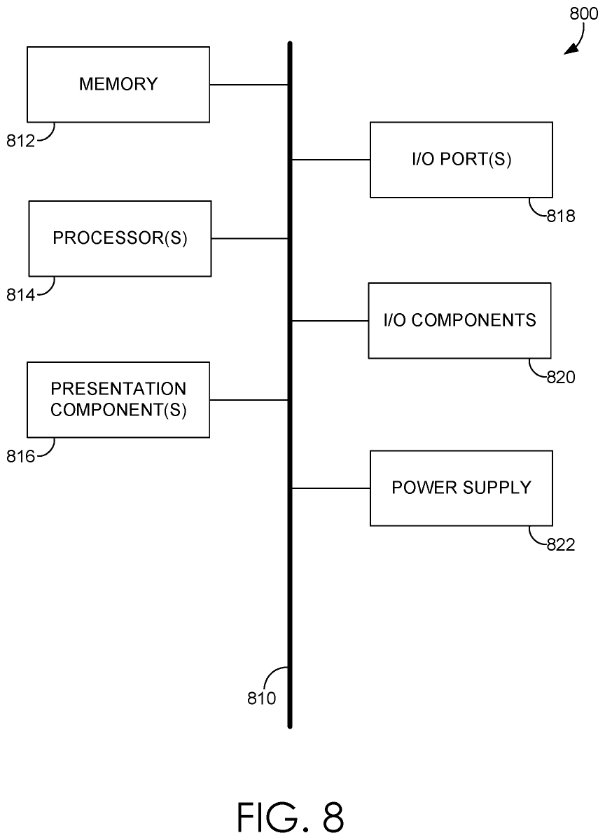

Aspects of the technical solution can be described by way of examples and with reference to FIGS. 2A and 2B. FIG. 2A is a block diagram of an exemplary technical solution environment, based on example environments described with reference to FIGS. 6, 7 and 7 for use in implementing embodiments of the technical solution are shown. Generally the technical solution environment includes a technical solution system suitable for providing the example electric vehicle management system 100 in which methods of the present disclosure may be employed. In particular, FIG. 2A shows a high level architecture of the electric vehicle management system 100 in accordance with implementations of the present disclosure. Among other engines, managers, generators, selectors, or components not shown (collectively referred to herein as “components”), the technical solution environment of electric vehicle management system 100 corresponds to FIGS. 1A and 1B.

With reference to FIG. 2A, FIG. 2A illustrates electric vehicle 110 with electric vehicle management client 112 including automotive navigation client 114, charging location search results interface data 116, charging location 120A, charging location search engine 130, electric vehicle data 140, user data 142, charging location data 150, ranking data 152, rating data 154, and location-based services 160.

The location-based services engine 160 aggregates charging location data for a plurality of charging locations with charging stations. The charging location data includes ranking data and rating data for a plurality of charging locations. The plurality of charging locations can include one or more charging stations. The location-based services engine 160 is integrated with the charging location search engine 130 such that the automotive navigation engine 110 operates as an integrated searching platform.

The charging location search engine 130 accesses a request for a charging location of an electric vehicle (EV) 110. The request includes charging location request attributes associated with the EV 110. The charging location request attributes can include user data and EV data that support determining the charging location. The request can be associated with a navigation route of the EV, such that the charging location recommendation is further generated based on the navigation route. The request is received from the EV 110 or a mobile device running the automotive navigation engine client 122. The EV 110 or and a user associated with the mobile device are associated with a plurality of attributes that are provided in the plurality of charging location request attributes.

The charging location search engine determines a charging location search result based on the plurality of charging location request attributes and one or more of ranking data or rating data. The charging location search engine 130 determines the charging location search result based on matching the plurality of charging location request attributes to charging location ranking features of the ranking data or charging location rating features of the rating data.

With reference to FIG. 2B, FIG. 2B illustrates a automotive navigation engine 110A, automotive navigation engine client 122, and charging location search engine 130 for providing a charging location search result based on a charging location search engine in an electric vehicle management system. At block 10, the automotive navigation engine 110A, identifies a plurality of charging location ranking features and a plurality of charging rating feature; at block 12, aggregates ranking data and rating data for a plurality of charging location; and at block 14, communicates the rating data and the ranking data to cause a charging location search engine to generate a charging location search result.

At block 16, the automotive navigation engine client 122, communicates a request for a charging location, the request comprises a plurality of charging location request attributes with an electric vehicle; at block 18, receives a charging location search result; and at block 20, causes presentation of charging location interface data associated with the charging location search result.

At block 22, the charging location search engine 130, accesses a request for a charging location for an electric vehicle (EV), the request comprising charging location request attributes associated with the EV; at block 22, determines a charging location search result based on the plurality of charging location attributes and the one or more of the following: ranking data or rating data; at block 26, communicate the charging location search result.

### Exemplary Methods

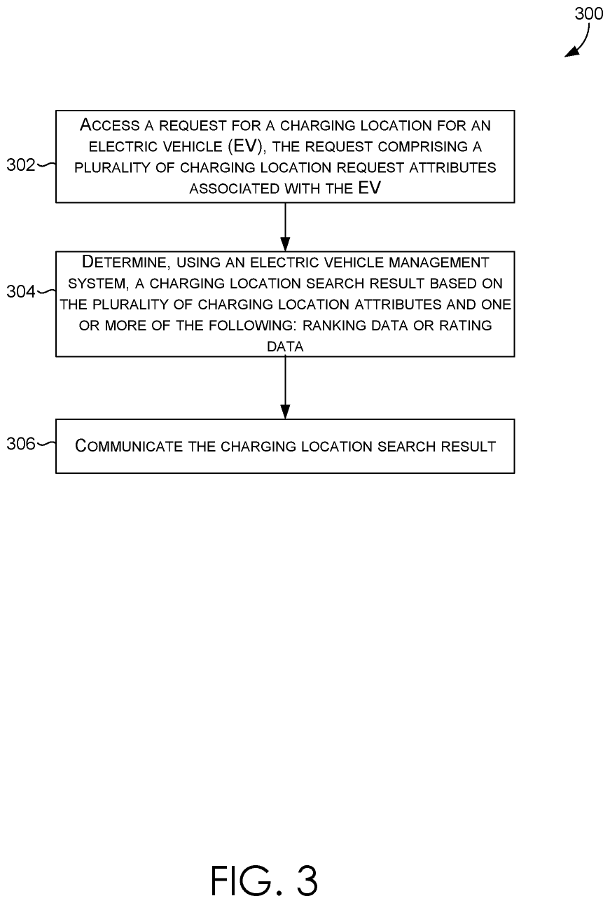

With reference to FIGS. 3, 4 and 5, flow diagrams are provided illustrating methods for providing a charging location search result based on a charging location search engine in an electric vehicle management system. The methods may be performed using the electric vehicle management system described herein. In embodiments, one or more computer-storage media having computer-executable or computer-useable instructions embodied thereon that, when executed, by one or more processors can cause the one or more processors to perform the methods (e.g., computer-implemented method) in the electric vehicle management system (e.g., a computerized system or computing system).

Turning to FIG. 3, a flow diagram is provided that illustrates a method 300 for providing a charging location search result based on a charging location search engine in an electric vehicle management system. At block 302, access a request for a charging location for an electric vehicle (EV). The request comprises a plurality of charging location request associated with the EV. At block 302, determine, using an electric vehicle management system, a charging location search result based on the plurality of charging location attributes and one or more of the following: ranking data or rating data. At block 304, communicate the charging location search result.

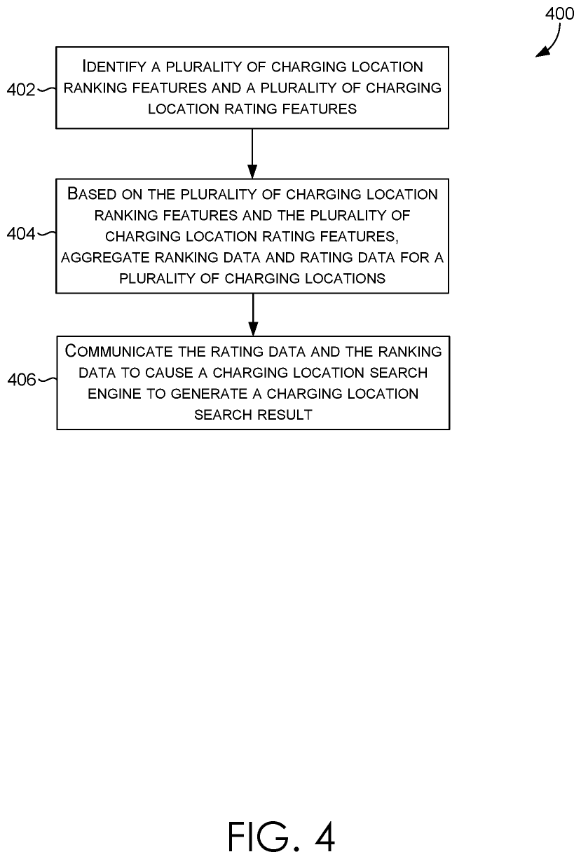

Turning to FIG. 4, a flow diagram is provided that illustrates a method 400 for providing a charging location search result based on a charging location search engine in an electric vehicle management system. At block 402, identify a plurality of charging location ranking features and a plurality of charging location rating features. At block 404, based on the plurality of charging location ranking features and the plurality of charging location rating features, aggregate ranking data and rating data for a plurality of charging locations. At block 406, communicate the rating data and the ranking data to cause a charging location search to generate a charging location search result.

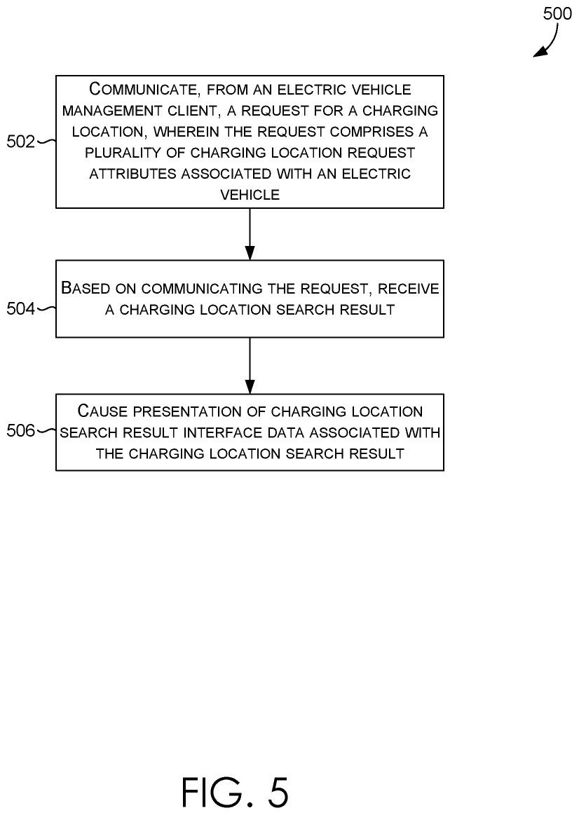

Turning to FIG. 5, a flow diagram is provided that illustrates a method 500 for providing a charging location search result based on a charging location search engine in an electric vehicle management system. At block 502, communicate, from an electric vehicle management client, a request for a charging location. The request comprises a plurality of charging location request attributes associated with an electric vehicle (EV). At block 504, based on communicating the request, receive a charging location search result. At block 506, cause presentation of charging location search result interface data associated the charging location search result.

### Example Electric Vehicle System

With reference to FIG. 6, FIG. 6 illustrates an example electric vehicle system 600 in which implementations of the present disclosure may be employed. In particular, FIG. 6 shows a high level architecture of an example electric vehicle distributed computing platform 600A and electric vehicle 600B having electric vehicle management resources 610A and electric vehicle management resources 610B, respectively, that support the functionality described herein. The electric vehicle system 600 can host a technical solution environment, or a portion thereof.

The electric vehicle distributed computing platform 600A includes electric vehicle management resources 610A that provide and support electric vehicle distributed computing systems and operations. Electric vehicle distributed computing platform 600A can run cloud services across different data centers and geographic regions. Typically the electric vehicle distributed computing platform 600A acts to store data or run service applications in a distributed manner. For example, a service application can be supported a computing environment (e.g., host, node, and virtual machine) and resources (e.g., hardware resources and software resources) that are configured the service application; and a client device may be linked to a service application and configured to issue commands to the service application. Communications in the electric vehicle distributed computing platform 600A are performed through a virtual Internet Protocol (IP) and over a network (not shown), which may include, without limitation, one or more local area networks (LANs) and/or wide area networks (WANs).

The electric vehicle 600B includes electric vehicle management resources 610B that provide and support electric vehicle systems and operations. Electric vehicle 600B can refer to a vehicle that uses electric power. The electric vehicle 600B can be built on a configuration for an automotive chassis used for automotive platforms of battery electric vehicles. The configuration can include a base structure that houses the batteries, electric motors, and other electronic components of the electric vehicle. By way of example, the electric vehicle can include a steering system, brake sensor system, and controller systems.

Controllers can include one or more systems on chips (SoCs) that may provide signals to one or more components and systems of the vehicle. For example, controllers can support a steering system, braking system, one or more onboard computing devices, artificial intelligence functionality (e.g., computer vision), infotainment functionality, global navigation satellite systems and sensors (e.g., Global Positioning System sensors, RADAR sensors, LIDAR sensors) and inertial measurement unit (IMU) sensors (e.g., accelerometers, gyroscopes). Controllers may receive inputs (e.g., represented by input data) from and provide outputs (e.g., represented by output data, display data, etc.) via a human-machine interface (HMI) display @134 and other components of the electric vehicle.

The electric vehicle further includes a network interface which may use one or more wireless antenna(s) and/or modem(s) to communicate over one or more networks. For example, the network interface may be capable of communication over LTE, WCDMA, UMTS, GSM, CDMA2000, etc. The wireless antenna(s) may also enable communication between objects in the environment (e.g., vehicles, mobile devices, etc.), using local area network(s), such as Bluetooth, Bluetooth LE, Z-Wave, ZigBee, etc., and/or low power wide-area network(s) (LPWANs), such as LoRaWAN, SigFox, etc.

It should be understood that this and other arrangements described herein are set forth as examples. For example, as described above, many elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown. The various blocks are shown with lines for the sake of conceptual clarity, and other arrangements of the described components and/or component functionality are also contemplated. FIG. 6 is merely meant to illustrative of an example electric vehicle and electric vehicle system that can be used in connection with one or more embodiments of the present invention.

### Example Computing Environment

Having briefly described an overview of embodiments of the present invention, an example operating environment in which embodiments of the present invention may be implemented is described below in order to provide a general context for various aspects of the present invention. Referring initially to FIG. 7 in particular, an example operating environment for implementing embodiments of the present invention is shown and designated generally as computing device 700. Computing device 700 is but one example of a suitable computing environment and is not intended to suggest any limitation as to the scope of use or functionality of the invention. Neither should computing device 700 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output ports 718, input/output components 720, and illustrative power supply 722. Bus 710 represents what may be one or more buses (such as an address bus, data bus, or combination thereof). The various blocks of FIG. 7 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 7 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc. Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. One or more computer-storage media having computer-executable instructions embodied thereon that, when executed by a computing system having a processor and memory, cause the processor to:
accessing a request for a charging location for an electric vehicle (EV), wherein the request comprises a plurality of charging location request attributes associated with the EV;
determining, using an electric vehicle management system, a charging location search result based on the plurality of charging location request attributes and one or more of the following: ranking data or rating data; and
communicating the charging location search result.

2. The one or more computer storage media of claim 1, the operations further comprising aggregating charging location data for a plurality of charging locations with charging stations, wherein the charging location data comprises ranking data and rating data of a plurality of charging locations.

3. The one or more computer storage media of claim 1, wherein the charging location request attributes include user data and EV data that support determining the charging location search result.

4. The one or more computer storage media of claim 1, wherein the request is received from the EV or a mobile device, the EV or the mobile device is associated a user having a plurality of user preferences in the plurality of charging location request attributes, wherein the charging location search result is communicated to the EV or the mobile device.

5. The one or more computer storage media of claim 1, wherein a charging location search engine and a location-based service of the electric vehicle management system are implemented as an integrated searching platform via an automotive navigation engine.

6. The one or more computer storage media of claim 1, wherein the request is associated with a navigation route of the EV, wherein the charging location is a charging location search result that is generated based on the navigation route.

7. The one or more computer storage media of claim 1, wherein determining charging location based on the plurality of charging location request attributes and one or more of the ranking data or rating data is based on matching the plurality of charging location request attributes to charging location ranking features of the ranking data or charging location rating features of the rating data.

8. A computerized system comprising:
one or more computer processors; and
computer memory storing computer-useable instructions that, when used by the one or more computer processors, cause the one or more computer processors to perform operations comprising:
accessing a request for a charging location for an electric vehicle (EV),
wherein the request comprises a plurality of charging location request attributes associated with the EV;
determining, using an electric vehicle management system, a charging location search result based on the plurality of charging location request attributes and one or more of the following: ranking data or rating data; and
communicating the charging location search result.

9. The computerized system of claim 8, the operations further comprising aggregating charging location data for a plurality of charging locations with charging stations, wherein the charging location data comprises ranking data and rating data of a plurality of charging locations.

10. The computerized system of claim 8, wherein the charging location request attributes include user data and EV data that support determining the charging location search result.

11. The computerized system of claim 8, wherein the request is received from the EV or a mobile device, the EV or the mobile device is associated a user having a plurality of user preferences in the plurality of charging location request attributes, wherein the charging location search result is communicated to the EV or the mobile device.

12. The computerized system of claim 8, wherein a charging location search engine and a location-based service of the electric vehicle management system are implemented as an integrated searching platform via an automotive navigation engine.

13. The computerized system of claim 8, wherein the request is associated with a navigation route of the EV, wherein the charging location is a charging location search result that is generated based on the navigation route.

14. The computerized system of claim 8, wherein determining charging location based on the plurality of charging location request attributes and one or more of the ranking data or rating data is based on matching the plurality of charging location request attributes to charging location ranking features of the ranking data or charging location rating features of the rating data.

15. A computer-implemented method, the method comprising:
accessing a request for a charging location for an electric vehicle (EV),
wherein the request comprises a plurality of charging location request attributes associated with the EV;
determining, using an electric vehicle management system, a charging location search result based on the plurality of charging location request attributes and one or more of the following: ranking data or rating data; and
communicating the charging location search result.

16. The computer-implemented method of claim 15, the method further comprising aggregating charging location data for a plurality of charging locations with charging stations, wherein the charging location data comprises ranking data and rating data of a plurality of charging locations.

17. The computer-implemented method of claim 15, wherein the charging location request attributes include user data and EV data that support determining the charging location search result.

18. The computer-implemented method of claim 15, wherein the request is received from the EV or a mobile device, the EV or the mobile device is associated a user having a plurality of user preferences in the plurality of charging location request attributes, wherein the charging location search result is communicated to the EV or the mobile device.

19. The computer-implemented method of claim 15, wherein the request is associated with a navigation route of the EV, wherein the charging location is a charging location search result that is generated based on the navigation route.

20. The computer-implemented method of claim 15, wherein determining charging location based on the plurality of charging location request attributes and one or more of the ranking data or rating data is based on matching the plurality of charging location request attributes to charging location ranking features of the ranking data or charging location rating features of the rating data.
